(19) United States
(12) Patent Application Publication
(10) Pub. No.: US 2024/0287245 A1
(43) Pub. Date: Aug. 29, 2024

(54) BIOMASS EPOXY RESIN COMPOSITION AND METHOD OF FORMING THE SAME AND OLIGOMER

(71) Applicant: INDUSTRIAL TECHNOLOGY RESEARCH INSTITUTE, Hsinchu (TW)

(72) Inventors: Yi-Syuan WANG, Taoyuan City (TW); Cheng-Han HSIEH, Changhua City (TW); Chih-Ming HU, Hsinchu City (TW)

(73) Assignee: INDUSTRIAL TECHNOLOGY RESEARCH INSTITUTE, Hsinchu (TW)

(21) Appl. No.: 18/414,191

(22) Filed: Jan. 16, 2024

(30) Foreign Application Priority Data
Feb. 23, 2023 (TW) 112106573

(51) Int. Cl. C08G 59/26; C08G 59/68

(52) U.S. Cl. CPC C08G 59/26; C08G 59/688

(57) ABSTRACT

A method of forming a biomass epoxy resin composition includes mixing 100 parts by weight of biomass 2,5-furandicarboxylic acid, 900 to 1100 parts by weight of epihalohydrin, and a catalyst to form a mixture. The method includes heating the mixture to 80° C. to 95° C. to react for 2 to 5 hours to form a ring-opening intermediate product, and adding an alkaline for ring closing the ring-opening intermediate product to form the biomass epoxy resin composition, wherein the catalyst includes 0.8 to 8 parts by weight of triphenyl phosphine and 0.01 to 0.1 parts by weight of 4-methoxyphenol.

### CROSS REFERENCE TO RELATED APPLICATIONS

The present application is based on, and claims priority from, Taiwan Application Serial Number 112106573, filed on Feb. 23, 2023, the disclosure of which is hereby incorporated by reference herein in its entirety.

### TECHNICAL FIELD

The technical field relates to a biomass epoxy resin composition and a method of forming the same and an oligomer.

### BACKGROUND

According to the research report “Top Value Added Chemicals from Biomass” in 2004 by the U.S. Department of Energy, 2,5-furan dicarboxylic acid (FDCA) ranks second among the top 12 new potential applicable biomass building block chemicals, which means that FDCA has considerable application potential. After more than ten years of development, FDCA is trial mass-produced and ready to be commercialized. If the purity of the product of polymerizing FDCA with another monomer can be enhanced, its application value will be greatly increased.

### SUMMARY

One embodiment of the disclosure provides a biomass epoxy resin composition, including:

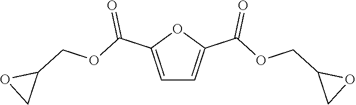 [SMILES: O=C(OCC1CO1)c1ccc(C(=O)OCC2CO2)o1]

and a self-polymerization polymer, wherein the self-polymerization polymer includes

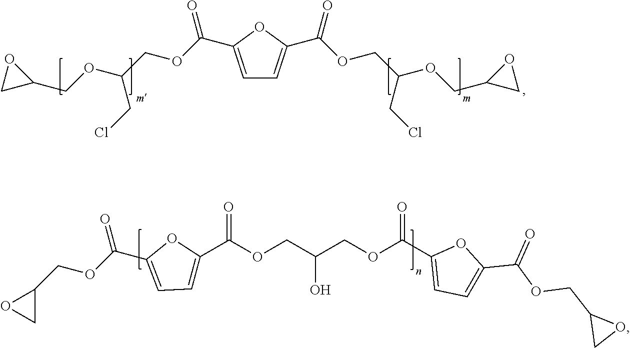

or a combination thereof, wherein m is 0 to 10, m′ is 0 to 10, m+m′≥1, and n is 1 to 10, wherein an ¹H NMR spectrum of the biomass epoxy resin composition has a signal integral value x of 3.4 ppm to 4.1 ppm, a signal integral value y of 4.6 ppm to 4.7 ppm, and 0<x/(x+y)<0.15.

One embodiment of the disclosure provides an oligomer, formed by reacting the described biomass epoxy resin composition with a diacid, a polyol, a hydroxyalkyl acid, or a combination thereof, wherein the diacid includes 2,5-furandicarboxylic acid, succinic acid, itaconic acid, adipic acid, azelaic acid, sebacic acid, oxalic acid, or a combination thereof, the polyol includes ethylene glycol, butylene glycol, sorbitol, or a combination thereof, and the hydroxyalkyl acid includes lactic acid.

One embodiment of the disclosure provides a method of forming a biomass epoxy resin composition. The method includes mixing 100 parts by weight of biomass 2,5-furandicarboxylic acid, 900 to 1100 parts by weight of epihalohydrin, and a catalyst to form a mixture. The method includes heating the mixture to 80° C. to 95° C. to react for 2 to 5 hours to form a ring-opening intermediate product. The method includes adding an alkaline for ring closing the ring-opening intermediate product to form a biomass epoxy resin composition, wherein the catalyst includes 0.8 to 8 parts by weight of triphenyl phosphine and 0.01 to 0.1 parts by weight of 4-methoxyphenol.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1A is an HPLC spectrum of an epoxy resin composition in one embodiment.

FIG. 1B is an 1H NMR spectrum of an epoxy resin composition in one embodiment.

FIG. 2 is an HPLC spectrum of an epoxy resin composition in one embodiment.

FIG. 3A is an HPLC spectrum of an epoxy resin composition in one embodiment.

FIG. 3B is an 1H NMR spectrum of an epoxy resin composition in one embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a method of forming a biomass epoxy resin composition, including: mixing 100 parts by weight of biomass 2,5-furandicarboxylic acid, 900 to 1100 parts by weight of epihalohydrin, and a catalyst to form a mixture. In some embodiments, the epihalohydrin can be epichlorohydrin. The epihalohydrin not only reacts with the biomass 2,5-furandicarboxylic acid, but also serves as a solvent. If the epihalohydrin amount is too high, the cost will be increased. If the epihalohydrin amount is too low, the solid content will be too high to stir and react.

Subsequently, the mixture is heated to 80° C. to 95° C. to react for 2 to 5 hours to form a ring-opening intermediate product. The reaction is shown below:

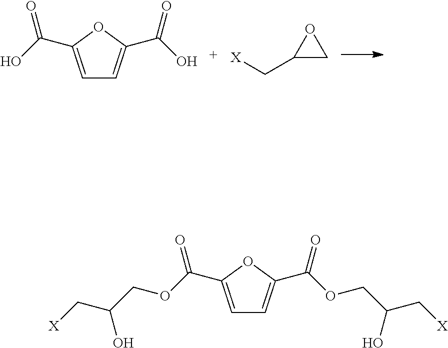

In the above reaction, X is a halogen such as chlorine. If the reaction temperature is too low or the reaction period is too short, the reaction will not occur or incomplete. If the reaction temperature is too high or the reaction period is too long, the self-polymerization polymer ratio in the product will be too high. In some embodiments, the catalyst includes 0.8 to 8 parts by weight of triphenyl phosphine and 0.01 to 0.1 parts by weight of 4-methoxyphenol. In some embodiments, the catalyst includes 0.9 to 5 parts by weight of triphenyl phosphine and 0.01 to 0.5 parts by weight of 4-methoxyphenol. In some embodiments, the catalyst includes 0.9 to 2.5 parts by weight of triphenyl phosphine and 0.01 to 0.1 parts by weight of 4-methoxyphenol. In some embodiments, the catalyst includes 0.9 to 1.1 parts by weight of triphenyl phosphine and 0.01 to 0.03 parts by weight of 4-methoxyphenol. If the triphenyl phosphine amount or the 4-methoxyphenol amount is too low, the reaction cannot occur.

Subsequently, an alkaline is added for ring closing the ring-opening intermediate product to form a biomass epoxy resin composition. The reaction is shown below:

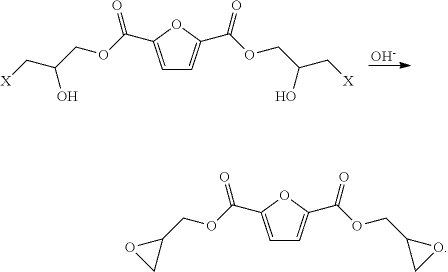

The biomass epoxy resin composition not only includes

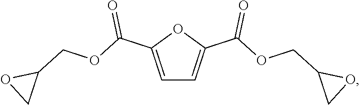 [SMILES: O=C(OCC1CO1)c1ccc(C(=O)OCC2CO2)o1]

but also a small amount of self-polymerization polymer. For example, the biomass epoxy resin composition may include

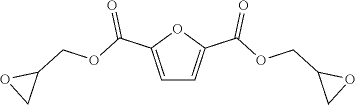 [SMILES: O=C(OCC1CO1)c1ccc(C(=O)OCC2CO2)o1]

and the self-polymerization polymer such as

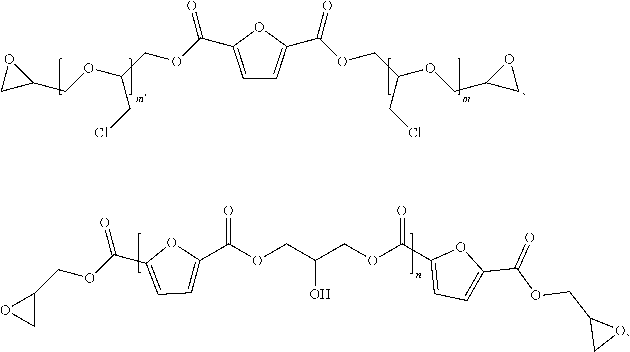

or a combination thereof, wherein m is 0 to 10, m′ is 0 to 10, m+m′≥1, and n is 1 to 10. An 1H NMR spectrum of the biomass epoxy resin composition has a signal integral value x of 3.4 ppm to 4.1 ppm, a signal integral value y of 4.6 ppm to 4.7 ppm, and 0<x/(x+y)<0.15. In some embodiments, 0<x/(x+y)<0.1. The signal integral value x of 3.4 ppm to 4.1 ppm mainly corresponds to the self-polymerization polymer, and the signal integral value y of 4.6 ppm to 4.7 ppm mainly corresponds to

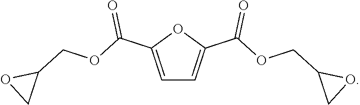 [SMILES: O=C(OCC1CO1)c1ccc(C(=O)OCC2CO2)o1]

If x is too high, the self-polymerization polymer ratio in the biomass epoxy resin composition will be too high. If the content of the self-polymerization polymer is too high, an additional separation process will be necessary to increase the process cost. In other words, if the content of the self-polymerization polymer in the biomass epoxy resin composition is low enough, an additional separation process can be omitted.

In some embodiments, using too much triphenyl phosphine during the process may lead to a higher x/(x+y) value, which means that the self-polymerization polymer ratio in the biomass epoxy resin composition will be too high. If the 4-methoxyphenol amount is too high, the x/(x+y) value will be easily too high, which means that the self-polymerization polymer ratio in the biomass epoxy resin composition will be too high.

In some embodiments, the biomass epoxy resin composition has a biomass content of 50 mol % to 100 mol %, which is mainly resulted from the biomass 2,5-furandicarboxylic acid. In some embodiments, the epihalohydrin can be a biomass material to further increase the biomass content of the biomass epoxy resin composition.

In some embodiments, the biomass epoxy resin composition has an epoxy equivalent of 134 g/eq to 150 g/eq. If the epoxy equivalent is too high, the self-polymerization polymer ratio in the biomass epoxy resin composition will be too high.

In some embodiments, the method further includes reacting the biomass epoxy resin composition with a diacid, a polyol, a hydroxyalkyl acid, or a combination thereof to form an oligomer, wherein the diacid includes 2,5-furandicarboxylic acid, succinic acid, itaconic acid, adipic acid, azelaic acid, sebacic acid, oxalic acid, or a combination thereof, the polyol includes ethylene glycol, butylene glycol, sorbitol, or a combination thereof, and the hydroxyalkyl acid includes lactic acid. In some embodiments, the diacid, the polyol, the hydroxyalkyl acid, or the combination thereof is a biomass material to increase the biomass content of the oligomer.

Accordingly, the disclosure provides a novel method to form the biomass epoxy

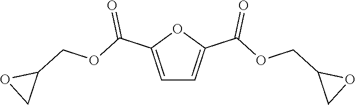 [SMILES: O=C(OCC1CO1)c1ccc(C(=O)OCC2CO2)o1]

resin composition containing a high ratio of and a small amount of self-polymerization polymer, thereby efficiently lowering the process cost of separating the self-polymerization polymer.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### Examples

In the following Examples, the conditions of the high performance liquid chromatography (HPLC) for analyzing the epoxy resin products are listed below. The sample injection volume: 1 μL. Column: XTERRA RP18 (3.5 μm*4.6 mm*250 mm) commercially available from Waters. Column temperature: 30° C. Eluent flow rate: 1.0 mL/min. Detector: UV-VIS spectrophotometer. Detection wavelength: 270 nm. Eluent: water and acetonitrile (v/v=1/1). Sample concentration: 100 ppm to 500 ppm, dissolved in acetonitrile. The retention time of

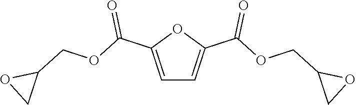 [SMILES: O=C(OCC1CO1)c1ccc(C(=O)OCC2CO2)o1]

in the sample was 4.10 minutes to 4.40 minutes. The retention time of the self-polymerization polymer

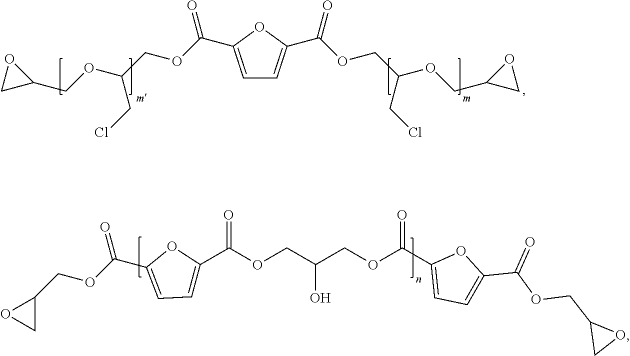

or a combination thereof in the sample was 0 minutes to 4.0 minutes and 4.5 minutes to 20.0 minutes.

In the following Examples, the self-polymerization polymer

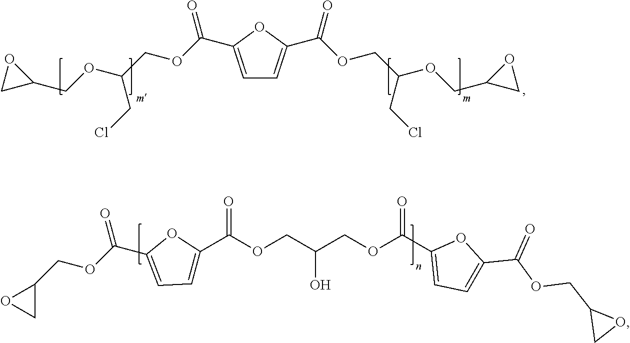

or a combination thereof had signals of 3.4 ppm to 4.1 ppm in the 1H NMR spectrum of the epoxy resin composition, and

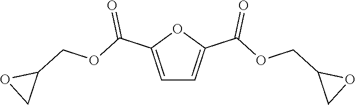 [SMILES: O=C(OCC1CO1)c1ccc(C(=O)OCC2CO2)o1]

had no signal of 3.4 ppm to 4.1 ppm.

In the following Examples, the epoxy equivalents of the epoxy resin compositions were measured using the following steps. 0.1 g to 0.3 g of sample was weighted and recorded. 1 mL of concentrated hydrochloric acid was added into 40 mL of acetone to prepare an acetone hydrochloride solution. 10 mL of the acetone hydrochloride solution and the sample were evenly stirred and stood for at least 1.5 hours, and 20 mL of acetone was then added. In addition, 20 mL of acetone was added into 10 mL of the acetone hydrochloride solution to prepare a blank solution. The sample solution and the blank solution were respectively titrated by a standard liquid of 0.1N NaOH solution, thereby recording the NaOH consumption amount to calculate the epoxy equivalent of the epoxy resin composition.

### Comparative Example 1

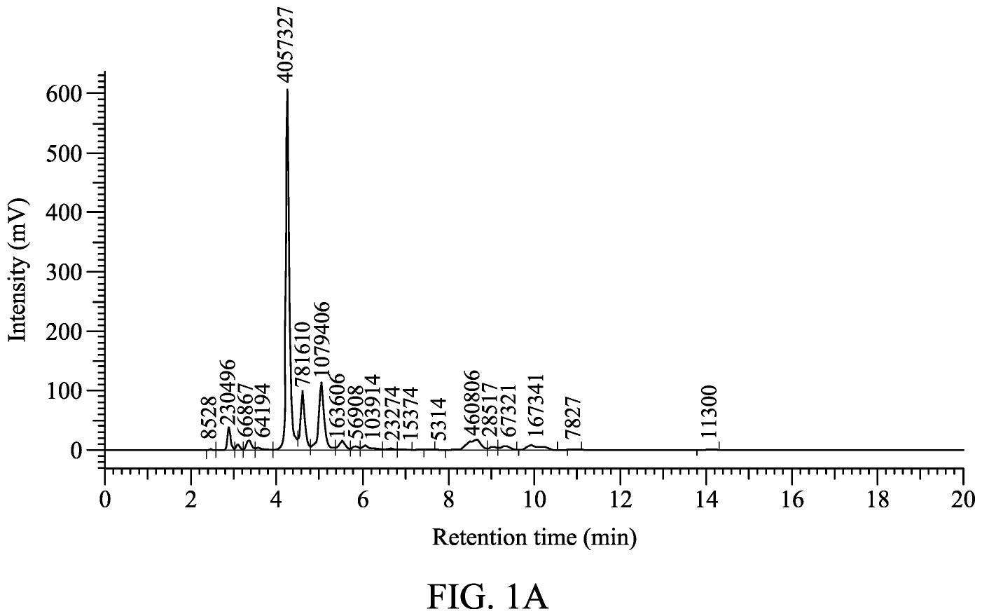

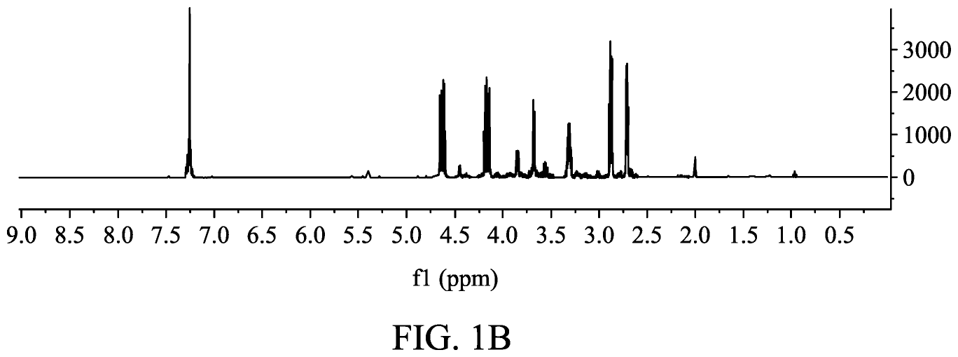

Biomass 2,5-furandicarboxylic acid (0.064 mole, 1 eq, 10 g), epichlorohydrin (1.08 mole, 16.8 eq, 100 g), and tetra-n-butylammonium bromide (3.1 mmole, 0.048 eq, 1 g) were put into a reaction bottle under nitrogen, mixed and heated to 100° C. to react for 1.5 hours, and then cooled to 30° C. 8 g of sodium hydroxide and 15 g of de-ionized water were added to the reaction bottle, and then reacted for additional 3 hours. The reaction result was cooled to room temperature (25° C.), and 15 g of de-ionized water was added to the reaction bottle to extract the organic layer (3 times). The solvent in the organic layer was then removed to obtain a solid, which was vacuumed at 50° C. to be dried to collect an epoxy resin composition. The epoxy resin composition had an HPLC purity (i.e. the ratio of the signal integral value of the retention time from 4.10 minutes to 4.40 minutes to the signal integral value of all time) of 53.82%, and an epoxy equivalent of 188 g/eq. The HPLC spectrum of the epoxy resin composition is shown in FIG. 1A, and the 1H NMR spectrum of the epoxy resin composition is shown in FIG. 1B. In FIG. 1A, the signals out of the retention time from 4.10 minutes to 4.40 minutes are obvious. In FIG. 1B, the signals of 3.4 ppm to 4.1 ppm are obvious. The epoxy equivalent of the epoxy resin composition was also much higher than 134 g/eq. Accordingly, the self-polymerization polymer ratio of the epoxy resin composition obtained in Comparative Example 1 was obviously too high, e.g. x/(x+y)=0.55.

### Comparative Example 2

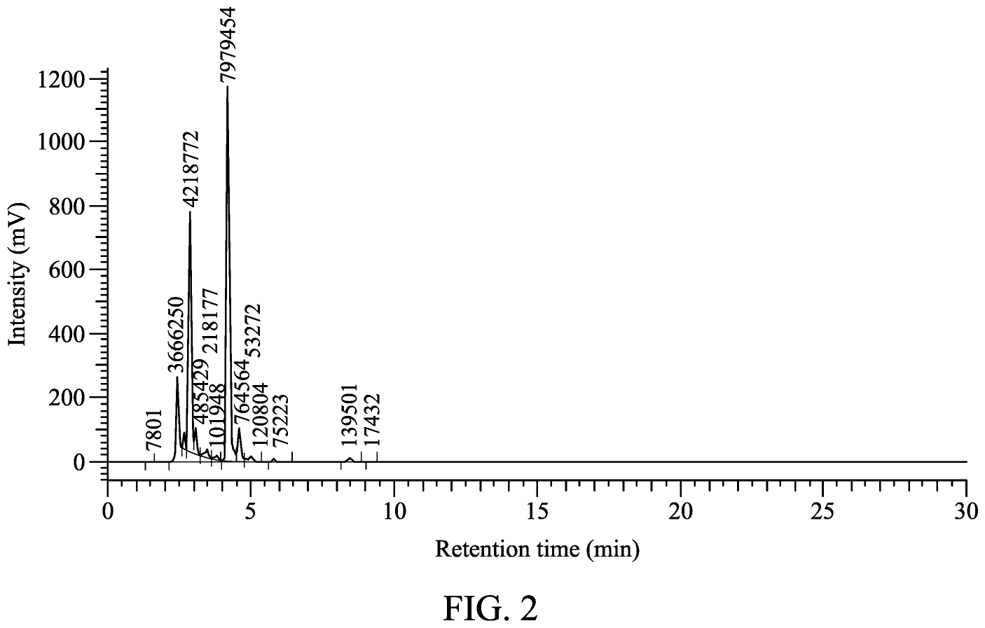

Biomass 2,5-furandicarboxylic acid (0.064 mole, 1 eq, 10 g) was dissolved in methanol (150 mL). Potassium hydroxide (0.14 mole, 7.8 g) was slowly added into the methanol solution at room temperature, and the mixture was stirred for 2 hours to precipitate potassium 2,5-furandicarboxylate (abbreviated as FDCA-K), which was put into a vacuum oven at 60° C. to be dried for 6 hours (yield=90%). Toluene (100 g), biomass epichlorohydrin (0.056 mole, 2 eq, 5.18 g), tetra-n-butylammonium bromide (2.80 mmole, 0.05 eq, 0.9026 g), and FDCA-K (0.056 mole, 1 eq, 13 g) were put into a reaction bottle under nitrogen, heated to reflux for 6 hours, and then filtered to remove the salt. The solvent of the filtrate was removed, and 100 mL of ultra-pure water was then added to extract the organic layer (3 times). The organic layer was vacuum dried to collect an epoxy resin composition. The epoxy resin composition had an HPLC purity (i.e. the ratio of the signal integral value of the retention time from 4.10 minutes to 4.40 minutes to the signal integral value of all time) of 44.07%, and an epoxy equivalent of 911 g/eq. The HPLC spectrum of the epoxy resin composition is shown in FIG. 2. In FIG. 2, the signals out of the retention time from 4.10 minutes to 4.40 minutes are obvious. The epoxy equivalent of the epoxy resin composition was also much higher than 134 g/eq. Accordingly, the self-polymerization polymer ratio of the epoxy resin composition obtained in Comparative Example 2 was obviously too high, e.g. x/(x+y)=0.60.

### Comparative Example 3

Biomass 2,5-furandicarboxylic acid (0.032 mole, 5 g) was dissolved in methanol (75 mL). Potassium hydroxide (0.07 mole, 3.9 g) was slowly added into the methanol solution at room temperature, and the mixture was stirred for 2 hours to precipitate potassium 2,5-furandicarboxylate (abbreviated as FDCA-K), which was put into a vacuum oven at 60° C. to be dried for 6 hours (yield-88%). Toluene (30 g), FDCA-K (0.021 mole, 1 eq, 5 g), epichlorohydrin (0.04 mole, 2 eq, 3.98 g), and 15-crown-5 (0.0215 mmole, 1 eq, 4.74 g) were put into a reaction bottle under nitrogen, heated to 50° C. to react for 16 hours. The solvent was then removed, and no reaction was occurred (determined by NMR).

### Comparative Example 4

Epichlorohydrin (1.02 mole, 16 eq, 94.4 g), 4-methoxyphenol (0.0015 mmole, 0.00024 eq, 0.19 mg), triphenyl phosphine (0.36 mmole, 0.0056 eq, 0.0941 g), and biomass 2,5-furandicarboxylic acid (0.064 mole, 1 eq, 10 g) were mixed under nitrogen, and then heated to 60° C. to react for 24 hours. Some solids could not be dissolved during the reaction. The solvent was then removed, and no reaction was occurred (determined by NMR).

### Comparative Example 5

Epichlorohydrin (1.02 mole, 16 eq, 94.4 g), 4-methoxyphenol (0.0015 mmole, 0.00024 eq, 0.19 mg), triphenyl phosphine (0.36 mmole, 0.0056 eq, 0.0941 g), and biomass 2,5-furandicarboxylic acid (0.064 mole, 1 eq, 10 g) were mixed under nitrogen, and then heated to 95° C. to react for 3 hours, and then heated to 115° C. to react for 3 hours. The solvent of the reaction result was removed to obtain an epoxy resin composition. The epoxy resin composition had an HPLC purity (i.e. the ratio of the signal integral value of the retention time from 4.10 minutes to 4.40 minutes to the signal integral value of all time) of 50.316%, and an epoxy equivalent of 205 g/eq. The epoxy equivalent of the epoxy resin composition was higher than 134 g/eq. Accordingly, the self-polymerization polymer ratio of the epoxy resin composition obtained in Comparative Example 5 was obviously too high, e.g. x/(x+y)=0.88.

### Comparative Example 6

Epichlorohydrin (1.02 mole, 16 eq, 94.4 g), triphenyl phosphine (0.36 mmole, 0.0056 eq, 0.0941 g), and biomass 2,5-furandicarboxylic acid (0.064 mole, 1 eq, 10 g) were mixed under nitrogen, and then heated to 95° C. to react for 8 hours. Some solids could not be dissolved during the reaction. The solvent was then removed, and no reaction was occurred (determined by NMR).

### Comparative Example 7

Epichlorohydrin (1.02 mole, 16 eq, 94.4 g), 4-methoxyphenol (0.0015 mmole, 0.00024 eq, 0.19 mg), and biomass 2,5-furandicarboxylic acid (0.064 mole, 1 eq, 10 g) were mixed under nitrogen, and then heated to 95° C. to react for 8 hours. Some solids could not be dissolved during the reaction. The solvent was then removed, and no reaction was occurred (determined by NMR).

### Comparative Example 8

Biomass 2,5-furandicarboxylic acid (0.064 mole, 1 eq, 10 g) and epichlorohydrin (1.02 mole, 16 eq, 94.4 g) were added into a four-neck bottle with a stirring rod, a thermometer, and a condenser. A 48.5% aqueous solution of sodium hydroxide (0.024 mole, 0.371 eq, 0.951 g) was added into the mixture at 50° C. under nitrogen of high purity to perform a pre-reaction for 4 hours. A 48.5% aqueous solution of sodium hydroxide (0.210 mole, 3.282 eq, 8.411 g) was then added to the bottle under a vacuum degree of 200 Torr to perform a ring-closing reaction for 5 hours. The epichlorohydrin was then recycled, and no reaction was occurred (determined by NMR).

### Example 1

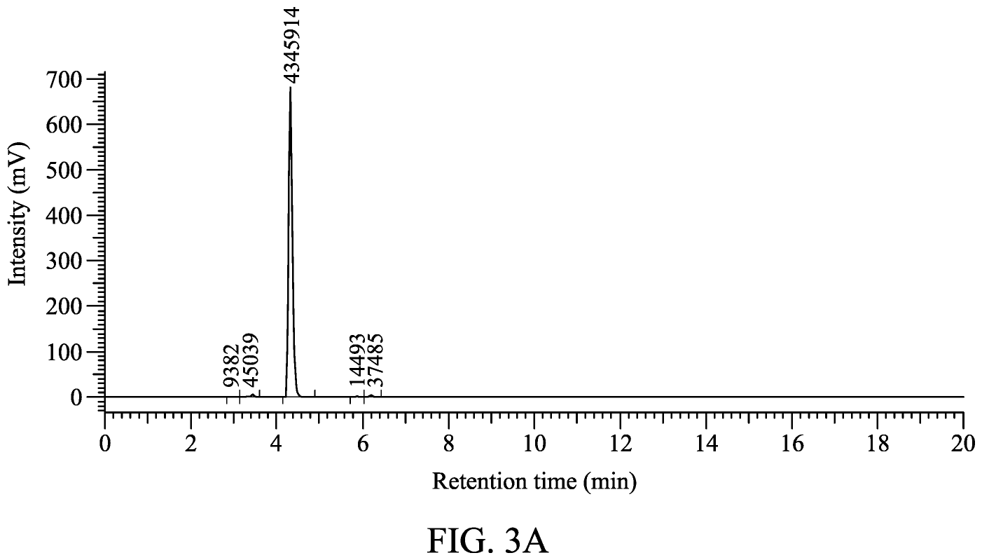

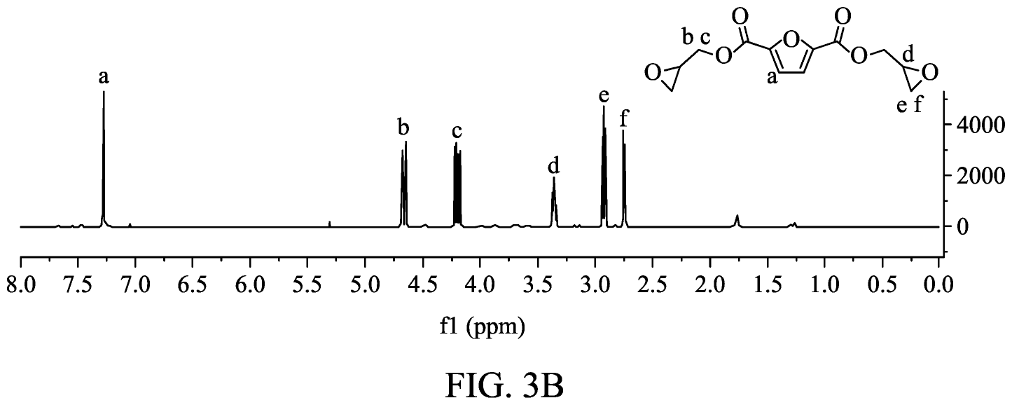

Biomass epichlorohydrin (10.2 mole, 16 eq, 944 g), 4-methoxyphenol (0.015 mmole, 0.0024 eq, 1.9 mg), triphenyl phosphine (3.5 mmole, 0.056 eq, 0.941 g), and biomass 2,5-furandicarboxylic acid (0.64 mole, 1 eq, 100 g) were mixed under nitrogen, and then heated to 85° C. to react for 5 hours. The solvent was removed, dichloromethane (11.77 mole, 20.08 eq, 1000 g) was added, and a 50% aqueous solution of sodium hydroxide (3 eq, 160.18 g) was slowly dropwise added. The mixture was reacted for 1 hour, and NaCl was then filtered out. 200 mL of ultra-pure water was added to the filtrate to extract the organic layer (3 times), and the solvent of the organic layer was removed by rotatory pump. The concentrated organic layer was baked at 60° C. to obtain an epoxy resin composition. The epoxy resin composition had an HPLC purity (i.e. the ratio of the signal integral value of the retention time from 4.10 minutes to 4.40 minutes to the signal integral value of all time) of 93.237%. The epoxy resin composition was recrystallized by THF/ethyl ether (50 mL/200 mL). The recrystallized product had an HPLC purity (i.e. the ratio of the signal integral value of the retention time from 4.10 minutes to 4.40 minutes to the signal integral value of all time) of 97.610%, an epoxy equivalent of 134 g/eq, and a biomass content of 96 mol % (measured according to the standard ASTM D6866-21 Method B (AMS)). The HPLC spectrum of the epoxy resin composition is shown in FIG. 3A, and the 1H NMR spectrum of the epoxy resin composition is shown in FIG. 3B. The hydrogen spectrum of the epoxy resin composition is shown below: 1H NMR (400 MHZ, CDCl₃): δ 2.75-2.73 (t, 2H, H_{f}), 2.31 (t, 2H, Hₑ), 3.37-3.35 (m, 2H, H_{d}), 4.24-4.22 (m, 2H, H_{c}), 4.68 (d, 2H, H_{b}), 7.30 (s, 2H, Hₐ). The positions of Hₐ, H_{b}, Hₑ, Hₐ, Hₑ, and H_{f} are shown in FIG. 3B. In FIG. 3A, there is almost no signal out of the retention time from 4.10 minutes to 4.40 minutes. In FIG. 3B, there is almost no signal from 3.4 ppm to 4.1 ppm. The epoxy equivalent of the epoxy resin composition was 134 g/eq. Accordingly, the self-polymerization polymer ratio of the epoxy resin composition obtained in Example 1 was little, e.g. x/(x+y) was about 0.07 (close to 0). The major composition of the epoxy resin composition was

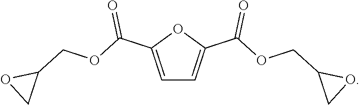 [SMILES: O=C(OCC1CO1)c1ccc(C(=O)OCC2CO2)o1]

### Example 2

Epichlorohydrin (9.73 mole, 16 eq, 944 g), 4-methoxyphenol (0.015 mmole, 0.0024 eq, 1.9 mg), triphenyl phosphine (3.5 mmole, 0.056 eq, 0.941 g), and biomass 2,5-furandicarboxylic acid (0.64 mole, 1 eq, 100 g) were mixed under nitrogen, and then heated to 95° C. to react for 3 hours. The solvent was removed, dichloromethane (11.77 mole, 20.08 eq, 1000 g) was added, and a 50% aqueous solution of sodium hydroxide (3 eq, 160.18 g) was slowly dropwise added. The mixture was reacted for 1 hour, and NaCl was then filtered out. 200 mL of ultra-pure water was added to the filtrate to extract the organic layer (3 times), and the solvent of the organic layer was removed by rotatory pump. The epoxy resin composition was recrystallized by THF/ethyl ether (50 mL/200 mL). The recrystallized product had an HPLC purity (i.e. the ratio of the signal integral value of the retention time from 4.10 minutes to 4.40 minutes to the signal integral value of all time) of 96.520%, an epoxy equivalent of 137 g/eq, and a biomass content of <58 mol % (measured according to the standard ASTM D6866-21 Method B (AMS)). Accordingly, the self-polymerization polymer ratio of the epoxy resin composition obtained in Example 2 was little, e.g. x/(x+y) was about 0.09. The major composition of the epoxy resin composition was

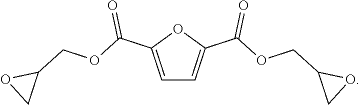 [SMILES: O=C(OCC1CO1)c1ccc(C(=O)OCC2CO2)o1]

### Comparative Example 9

Epichlorohydrin (0.973 mole, 16 eq, 94.4 g), 4-methoxyphenol (0.0015 mmole, 0.00024 eq, 0.19 mg), triphenyl phosphine (3.5 mmole, 0.056 eq, 0.941 g), and biomass 2,5-furandicarboxylic acid (0.064 mole, 1 eq, 10 g) were mixed under nitrogen, and then heated to 95° C. to react for 1 hours. The solvent was removed, dichloromethane (1.177 mole, 20.08 eq, 100 g) was added, and a 50% aqueous solution of sodium hydroxide (3 eq, 16.018 g) was slowly dropwise added. The mixture was reacted for 1 hour, and NaCl was then filtered out. 20 mL of ultra-pure water was added to the filtrate to extract the organic layer (3 times), and the solvent of the organic layer was removed by rotatory pump. The epoxy resin composition was recrystallized by THF/ethyl ether (5 mL/20 mL). The recrystallized product had an HPLC purity (i.e. the ratio of the signal integral value of the retention time from 4.10 minutes to 4.40 minutes to the signal integral value of all time) of 68.458%, an epoxy equivalent of 258.50 g/eq, and a biomass content of <58 mol % (measured according to the standard ASTM D6866-21 Method B (AMS)). Accordingly, the self-polymerization polymer obtained in Comparative Example 9 was too high, e.g. x/(x+y)=0.61.

### Comparative Example 10

Epichlorohydrin (0.973 mole, 16 eq, 94.4 g), 4-methoxyphenol (0.15 mmole, 0.024 eq, 19 mg), triphenyl phosphine (0.35 mmole, 0.0056 eq, 0.0941 g), and biomass 2,5-furandicarboxylic acid (0.064 mole, 1 eq, 10 g) were mixed under nitrogen, and then heated to 95° C. to react for 3 hours. The solvent was removed, dichloromethane (11.77 mole, 20.08 eq, 1000 g) was added, and a 50% aqueous solution of sodium hydroxide (3 eq, 16.018 g) was slowly dropwise added. The mixture was reacted for 1 hour, and NaCl was then filtered out. 200 mL of ultra-pure water was added to the filtrate to extract the organic layer (3 times), and the solvent of the organic layer was removed by rotatory pump. The epoxy resin composition was recrystallized by THE/ethyl ether (5 mL/20 mL). The recrystallized product had an HPLC purity (i.e. the ratio of the signal integral value of the retention time from 4.10 minutes to 4.40 minutes to the signal integral value of all time) of 74.669%, an epoxy equivalent of 216.79 g/eq, and a biomass content of <58 mol % (measured according to the standard ASTM D6866-21 Method B (AMS)). Accordingly, the self-polymerization polymer obtained in Comparative Example 10 was too high, e.g. x/(x+y)=0.62.

### Example 3

Epichlorohydrin (0.973 mole, 16 eq, 94.4 g), 4-methoxyphenol (0.0015 mmole, 0.00024 eq, 0.19 mg), triphenyl phosphine (0.35 mmole, 0.0056 eq, 0.0941 g), and a recycled biomass 2,5-furandicarboxylic acid (0.064 mole, 1 eq, 10 g) were mixed under nitrogen, and then heated to 95° C. to react for 3 hours. The solvent was removed, dichloromethane (11.77 mole, 20.08 eq, 1000 g) was added, and a 50% aqueous solution of sodium hydroxide (3 eq, 160.18 g) was slowly dropwise added. The mixture was reacted for 1 hour, and NaCl was then filtered out. 200 mL of ultra-pure water was added to the filtrate to extract the organic layer (3 times), and the solvent of the organic layer was removed by rotatory pump. The epoxy resin composition was recrystallized by THF/ethyl ether (50 mL/200 mL). The recrystallized product had an HPLC purity (i.e. the ratio of the signal integral value of the retention time from 4.10 minutes to 4.40 minutes to the signal integral value of all time) of 96.757%, an epoxy equivalent of 147.73 g/eq, and a biomass content of <58 mol % (measured according to the standard ASTM D6866-21 Method B (AMS)). Accordingly, the self-polymerization polymer ratio of the epoxy resin composition obtained in Example 3 was little, e.g. x/(x+y) was about 0.07. The major composition of the epoxy resin composition was

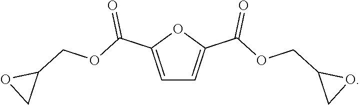 [SMILES: O=C(OCC1CO1)c1ccc(C(=O)OCC2CO2)o1]

### Example 4

Diglycidyl ester of 2,5-furandicarboxylic acid (0.0185 mole, 1 eq, 5 g) was put into 250 mL of a single-neck round bottom bottle, which was heated in a water bath at 90° C. under a reduced pressure of 200 Torr for 30 minutes to be melted from a solid state to a liquid state. 2,5-furandicarboxylic acid (0.0016 mole, 0.086 eq, 0.25 g), 4-methoxyphenol (0.0007 mmole, 0.00024 eq, 0.095 mg), and triphenyl phosphine (1.75 mmole, 0.056 eq, 0.47 g) were then added into the bottle. The mixture was continuously rotated for 2 hours to be evenly mixed and reacted to a homogeneous phase, and then stood at room temperature and the vacuum was broken. The product has a polymerization degree of 52.52% (determined by NMR) and an epoxy equivalent of 353.01 g/eq.

The epoxy resin product was analyzed by HPLC, in which the ratio of the signal integral value of the retention time from 4.10 minutes to 4.40 minutes to the signal integral value of the retention time from 0 minutes to 4.0 minutes and from 4.5 minutes to 20.0 minutes was greater than 90% or even greater than 95%.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A biomass epoxy resin composition, comprising: 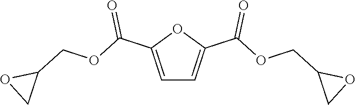 [SMILES: O=C(OCC1CO1)c1ccc(C(=O)OCC2CO2)o1]
and a self-polymerization polymer, wherein the self-polymerization polymer includes 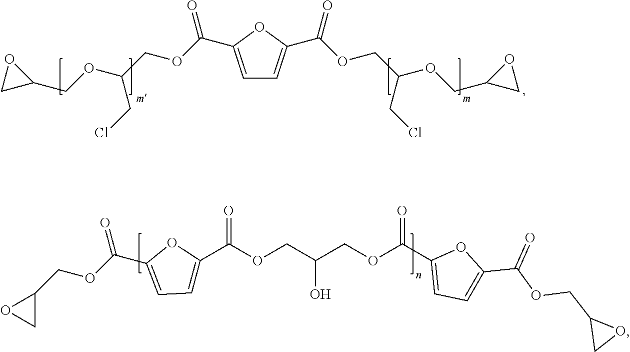
or a combination thereof, wherein m is 0 to 10, m′ is 0 to 10, m+m′≥1, and n is 1 to 10,
wherein an 1H NMR spectrum of the biomass epoxy resin composition has a signal integral value x of 3.4 ppm to 4.1 ppm, a signal integral value y of 4.6 ppm to 4.7 ppm, and 0<x/(x+y)<0.15.

2. The biomass epoxy resin composition as claimed in claim 1, wherein the biomass epoxy resin composition has an epoxy equivalent of 134 g/eq to 150 g/eq.

3. The biomass epoxy resin composition as claimed in claim 1, wherein the biomass epoxy resin composition has a biomass content of 50 mol % to 100 mol %.

4. An oligomer, being formed by reacting the biomass epoxy resin composition as claimed in claim 1 with a diacid, a polyol, a hydroxyalkyl acid, or a combination thereof, wherein the diacid comprises 2,5-furandicarboxylic acid, succinic acid, itaconic acid, adipic acid, azelaic acid, sebacic acid, oxalic acid, or a combination thereof, the polyol comprises ethylene glycol, butylene glycol, sorbitol, or a combination thereof, and the hydroxyalkyl acid comprises lactic acid.

5. The oligomer as claimed in claim 4, wherein the diacid, the polyol, the hydroxyalkyl acid, or the combination thereof is a biomass material.

6. A method of forming a biomass epoxy resin composition, comprising:
mixing 100 parts by weight of biomass 2,5-furandicarboxylic acid, 900 to 1100 parts by weight of epihalohydrin, and a catalyst to form a mixture;
heating the mixture to 80° C. to 95° C. to react for 2 to 5 hours to form a ring-opening intermediate product, and
adding an alkaline for ring closing the ring-opening intermediate product to form a biomass epoxy resin composition,
wherein the catalyst includes 0.8 to 8 parts by weight of triphenyl phosphine and 0.01 to 0.1 parts by weight of 4-methoxyphenol.

7. The method as claimed in claim 6, wherein the epihalohydrin is a biomass material.

8. The method as claimed in claim 6, wherein the biomass epoxy resin composition has an epoxy equivalent of 134 g/eq to 150 g/eq.

9. The method as claimed in claim 6, wherein an 1H NMR spectrum of the biomass epoxy resin composition has a signal integral value x of 3.4 ppm to 4.1 ppm, a signal integral value y of 4.6 ppm to 4.7 ppm, and 0<x/(x+y)<0.15.

10. The method as claimed in claim 6, further comprising:
reacting the biomass epoxy resin composition with a diacid, a polyol, a hydroxyalkyl acid, or a combination thereof to form an oligomer,
wherein the diacid comprises 2,5-furandicarboxylic acid, succinic acid, itaconic acid, adipic acid, azelaic acid, sebacic acid, oxalic acid, or a combination thereof, the polyol comprises ethylene glycol, butylene glycol, sorbitol, or a combination thereof, and the hydroxyalkyl acid comprises lactic acid.

11. The method as claimed in claim 10, wherein the diacid, the polyol, the hydroxyalkyl acid, or the combination thereof is a biomass material.
